(19) United States
(12) Patent Application Publication
(10) Pub. No.: US 2024/0396659 A1
(43) Pub. Date: Nov. 28, 2024

(54) A BROADCAST-AND-SELECT NODE

(71) Applicant: Telefonaktiebolaget LM Ericsson (publ), Stockholm (SE)

(72) Inventors: Luca GIORGI, Pisa (IT); Fabio CAVALIERE, Pisa (IT); Paola IOVANNA, Pisa (IT)

(21) Appl. No.: 18/697,186

(22) PCT Filed: Jul. 29, 2021
(86) PCT No.: PCT/EP2021/071356

§ 371 Date: Mar. 29, 2024

(51) Int. Cl. H04J 14/02; H04B 10/032

(52) U.S. Cl. CPC H04J 14/0204; H04B 10/032; H04J 14/0228

(57) ABSTRACT

A first Broadcast-and-Select (B&S) node includes a first downstream port coupled to a first downstream power splitter/combiner, a second downstream port coupled to a second downstream power splitter/combiner, and a third downstream port coupled to a third downstream power splitter/combiner. The first downstream power splitter/combiner is configured to split a total power of a first downstream optical signal received at the first downstream port to form a first version and a second version of the first downstream optical signal, the second power splitter/combiner is configured to: receive the first version of the first downstream optical signal, and transmit the first version of the first downstream optical signal to a first network node via the second downstream port, the third downstream power splitter/combiner is configured to: receive the second version of the first downstream optical signal.

### TECHNICAL FIELD

Embodiments described herein relate methods and apparatuses for dealing with upstream and downstream signals in a Broadcast-and-Select, B&S, node. The B&S node may be configured for use in a B&S network architecture.

### BACKGROUND

Typical wavelength-division multiplexing (WDM) networks are based on wavelength multiplexers and demultiplexers, and optical add-drop multiplexers (OADMs).

An OADM will be configured to extract, from an input wavelength comb (or signal), one or more individual wavelengths that are then to be transmitted to a respective receiver. An OADM will also be configured to receive one or more wavelengths that are to be transmitted to a receiver within the WDM network. The OADM is configured to aggregate the one or more received wavelengths prior to transmitting them via a single output port of the OADM.

As such, an OADM will be configured such that it comprises a plurality of add ports configured to receive signals to be aggregated, and a plurality of drop ports configured to transmit the extracted wavelengths from the input wavelength comb. The add ports and drop ports may therefore be respectively configured to “add” or “drop” a predetermined wavelength. Some OADMs may be reconfigurable, such that the predetermined wavelength associated with each port may be varied.

FIG. 1 illustrates an example WDM network 100, comprising a hub node 102, and four OADM nodes 104a, 104b, 104c, 104d, arranged in a fiber ring configuration. The hub node 102 may be positioned in a central office, or a local exchange, for example.

In this illustrated example, two fiber rings are present in the fiber ring configuration. The first fiber ring 106 couples a first downstream port R1 of the hub node 102, and a second downstream port R′1 of the hub node 102. The second fiber ring 108 couples a first upstream port R2 of the hub node 102, and a second upstream port R′2 of the hub node 102. It will be appreciated that any number of OADM nodes may be coupled between the first downstream port R1 and the second downstream port R′1 on the first fiber ring 106, and that any number of OADM nodes may be coupled between the first upstream port R2 and the second upstream port R′2 on the second fiber ring 108.

In this illustrated example, the first downstream port R1 is configured as “working port” of the hub node 102. In other words, during a working mode of operation (generally used when no faults are present in the WDM network), the hub node may utilize the first downstream port R1 to transmit a downstream signal. The second downstream port R′1 is configured as a “protection port” of the hub node 102. In other words, the second downstream port R′1 is only used by the hub node 102 to transmit a downstream signal in a protection mode of operation (e.g. when a fault has been detected in the WDM network).

The upstream ports R2 and R′2 may be used in both the working mode and protection mode of operation (as will be described in more detail later).

The first fiber ring 106 is reserved for downstream communication from the hub node 102 via each of four OADM nodes 104a, 104b, 104c, 104d to a plurality of destination tail-end nodes for downstream signals. In the case of a working mode of operation, one or more initial downstream signals, each comprising a different set of wavelengths, are multiplexed by the hub node 102 and transmitted as a single downstream signal along the first fiber ring 106 via the first downstream port R1. Following this, at each respective OADM node 104a, 104b, 104c, 104d, one or more wavelengths will be dropped from the downstream signal, and transmitted to a respective receiver at a tail-end node. For example, the set of wavelengths corresponding to one of the initial downstream signals may be dropped at each OADM node and transmitted to a receiver at a tail-end node.

The second fiber ring 108 is reserved for upstream communication from the tail end nodes via each of four OADM nodes 104a, 104b, 104c, 104d to the hub node 102. For the case of a working mode of the WDM network 100, at each respective OADM node 104a, 104b, 104c, 104d, an initial upstream signal comprising a set of one or more wavelengths will be received from a respective transmitter at a tail end node, and an upstream signal will be formed by the OADM node that comprises these one or more wavelengths (for example, the one or more wavelengths may be added to an existing upstream signal by the OADM node). The existing upstream signal may be received at the OADM node from a previous OADM node in the second fiber ring 108 or from the hub node 102.

At each OADM node, the formed upstream signal will then be transmitted via both a first upstream port Aw and a second upstream port A_{E} of the OADM node. It will therefore be appreciated that two copies of the formed upstream signal will respectively arrive at the first upstream port R2 and the second upstream port R′2 of the hub node 102. The hub node 102 will then demultiplex the received upstream signal to separate out the initial upstream signals, each comprising a different set of wavelengths from the received upstream signal.

When a fault occurs in the WDM network 100, the WDM network 100 will enter the protection mode of operation. As described above, in protection mode, a copy of the downstream signal will also be transmitted to onto the first fiber ring 106 via the second downstream port R′1 of the hub node 102.

Additionally, in protection mode, two different upstream signals will be received at the hub node 102, the first upstream signal being received at the first upstream port R2, and the second upstream signal being received at the second upstream port R′2. In other words, the upstream signals received at the first upstream port R2 and the second upstream port R′2 will differ as the fault in the network will prevent upstream signals on one side of the fault from passing the fault to reach either the first upstream port R2 or the second upstream port R′2. For example, if a fault occurs at OADM 104b, then upstream signals transmitted from port A_{E} of OADM 104a will not reach the second upstream port R′2, however, they will reach upstream port R2.

The hub node 102 may therefore combine the signals received at the first upstream port R2 and the second upstream port R′2 in order to generate the full upstream signal.

It will be appreciated that, in order to enable the aforementioned protection mode of operation in the WDM network 100, the OADM nodes 104a, 104b, 104c, 104d must be configured to drop the correct wavelengths (that are to be transmitted to a respective receiver) regardless of whether the downstream signal originated from the first downstream port R1 or the second downstream port R′1 of the hub node 102. Additionally, the OADM nodes 104a, 104b, 104c, 104d must be configured to form an upstream signal, and to then transmit this formed upstream signal in towards both the first upstream node R2 and the second upstream node R′2 on the second fiber ring 108.

It will also be appreciated that conventional WDM networks, that are based on non-reconfigurable wavelength selective devices (such as OADMs), may rigidly map particular wavelengths to network node ports. Such a WDM network may therefore require many variants of these non-reconfigurable wavelength selective devices to be utilized within the network (for example, one device may be needed per required wavelength, or per set of required wavelengths). This may therefore result in increased operational issues for the network and/or increased costs (for example, due to inventory, required numbers of spare parts and/or network planning constraints). Although reconfigurable devices, (for example, reconfigurable OADM nodes) may overcome some of these aforementioned issues these devices themselves may result in increased costs, which may be prohibitive for fronthaul or, mobile transport applications.

In addition, as 5G technology continues to develop, 5G networks may introduce additional demands on existing access network infrastructure (for example, on the existing infrastructure in the last mile of an access network). In some examples, this may result in the introduction of additional demands on one or more OADMs comprised within a WDM network. It will be appreciated that, in order to support these additional demands, additional OADMs may need to be installed within a WDM network, which may be an expensive and/or complex process.

Alternative WDM network architectures may not comprise OADM nodes. For example, in some WDM network architectures, a wavelength selection function may be performed, for example, at the tail-end nodes by the transceiver itself (for example, by means of a tuneable laser), and power splitters may be used within the WDM network instead of performing any wavelength selection. A tuneable filter may also be utilized by a transceiver to selectively transmit wavelengths to the power splitters.

For example, for non-coherent optical signals, a tunable optical filter may be used at a receiver for direct detection of the optical signal. However, for a coherent optical signal, a local oscillator may be used in the receiver to detect and select a particular wavelength.

One example of such an alternative architecture (hereinafter referred to as a Broadcast-and-Select (B&S) architecture) is a wavelength-select WDM Passive Optical Network (PON) (WS-PON) architectures (also referred to as a PON architecture with WDM overlay), which may be of interest for supporting fronthaul applications over installed PON infrastructures.

Another example of such a B&S architecture may comprise a chain of optical add-drop nodes. In this example, each of the optical add-drop nodes respectively comprise a passive splitter that is configured to tap a WDM optical signal along an optical fiber (or bus) and broadcast the tapped signal over a number of optical ports. The portion of the optical signal that is not tapped may then continue to propagate in the network and be received at the next optical add-drop node in the chain. This architecture may be used in fronthaul applications to connect a baseband processing node to distant remote units placed at different locations, for example.

A B&S architecture such as those described above, may assist in moving network costs from the device that is used for optical adding and dropping to a more easily reconfigurable transceiver. The overall cost of the B&S architecture may therefore increase when the network itself grows, due to an increasing number of transceivers. However, the power splitters may introduce a high insertion loss, which may impair the sensitivity of the network to received power and the optical signal to noise ratio.

It will also be appreciated that, in mobile transport and access networks, bidirectional (BiDi) transmission on a single fiber may be desirable (for example, for cost reasons, and to simplify the network installation). It may also be desirable to implement traffic protection schemes for this kind of bidirectional architecture (similarly to as described above with reference to FIG. 1). However, introducing such protection schemes in these B&S architectures usually requires duplication of equipment (e.g. duplication of the entire network), undermining the fundamental motivation of introducing a B&S architecture, which is cost effectiveness.

### SUMMARY

According to some embodiments, there is provided a first Broadcast-and-Select, B&S, node. The first B&S node comprises a first downstream port coupled to a first downstream power splitter/combiner, a second downstream port coupled to a second downstream power splitter/combiner, and a third downstream port coupled to a third downstream power splitter/combiner. The first downstream power splitter/combiner is configured to split a total power of a first downstream optical signal received at the first downstream port to form a first version and a second version of the first downstream optical signal, the second power splitter/combiner is configured to: receive the first version of the first downstream optical signal, and transmit the first version of the first downstream optical signal to a first network node via the second downstream port, the third downstream power splitter/combiner is configured to: receive the second version of the first downstream optical signal, and transmit the second version of the first downstream optical signal to a second network node via the third port.

According to some embodiments, there is provided a second Broadcast-and-Select, B&S, node. The second B&S node comprises a first upstream port coupled to a first upstream power splitter/combiner, a second upstream port coupled to a second upstream power splitter/combiner, and a third upstream port coupled to a third upstream power splitter/combiner. The second upstream power splitter/combiner is configured to split a total optical power of a first upstream optical signal received at the second upstream port to form a first version and a second version of the first upstream optical signal, the first upstream power splitter/combiner is configured to receive the first version of the first upstream optical signal and transmit the first version of the first upstream optical signal to a third network node via the first upstream port, and the third upstream power splitter/combiner is configured to receive the second version of the first upstream optical signal and transmit the second version of the first upstream optical signal to a second network node via the third upstream port.

In some embodiments, there is provided a method of dropping a downstream optical signal at a Broadcast-and-Select, B&S, node, wherein the downstream optical signal is intended to be received at a plurality of B&S node. The method comprises receiving a first downstream optical signal from a third network node; splitting a total optical power of the first downstream optical signal to form a first version of the first downstream optical signal and a second version of the first downstream optical signal; transmitting the first version of the first downstream optical signal to a first network node; and transmitting the second version of the first downstream optical signal to a second network node.

In some embodiments, there is provided a method, in a Broadcast-and-Select, B&S, node, of transmitting a first upstream optical signal, wherein the first upstream optical signal is intended to be received at a plurality of B&S nodes. The method comprises receiving the first upstream optical signal from a first network node; splitting a total power of the first upstream optical signal to form a first version of the first upstream optical signal and a second version of the first upstream optical signal; transmitting the first version of the first upstream optical signal to a third network node; and transmitting the second version of the first upstream optical signal to a second network node.

In some embodiments, there is provided a third Broadcast-and-Select, B&S, node for dropping a downstream optical signal at the third B&S node, wherein the downstream optical signal is intended to be received at a plurality of B&S nodes. The third B&S node comprises processing circuitry configured to receive a first downstream optical signal from a third network node; split a total optical power of the first downstream optical signal to form a first version of the first downstream optical signal and a second version of the first downstream optical signal; transmit the first version of the first downstream optical signal to a first network node; and transmit the second version of the first downstream optical signal to a second network node.

In some embodiments, there is provided a fourth Broadcast-and-Select, B&S, node for transmitting a first upstream optical signal, wherein the first upstream optical signal is intended to be received at a plurality of B&S nodes. The fourth B&S node comprises processing circuitry configured to receive the first upstream optical signal from a first network node; split a total power of the first upstream optical signal to form a first version of the first upstream optical signal and a second version of the first upstream optical signal; transmit the first version of the first upstream optical signal to a third network node; and transmit the second version of the first upstream optical signal to a second network node.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example WDM network 100;

FIG. 2 illustrates an example of a first Broadcast-and-Select, B&S, node 200;

FIG. 3 illustrates an example B&S network 300;

FIG. 4 illustrates a flowchart of a method 400 of dropping a downstream optical signal at a Broadcast-and-Select, B&S, node, wherein the downstream optical signal is intended to be received at a plurality of B&S nodes;

FIG. 5 illustrates a flowchart of a method 500, in a Broadcast-and-Select, B&S, node, of transmitting a first optical signal, wherein the first optical signal is intended to be received at a plurality of B&S nodes;

FIGS. 6a and 6b illustrate a hub node 302 configured to implement a protection mode in a network 300;

FIG. 7 illustrates an alternative B&S network 700;

FIG. 8 illustrates a B&S node 800;

FIG. 9 illustrates an extended B&S node system 900;

FIG. 10 is a schematic of an example of an apparatus 1000 for dropping a downstream optical signal at a Broadcast-and-Select, B&S, node, wherein the downstream optical signal is intended to be received at a plurality of B&S nodes; and

FIG. 11 is a schematic of an example of an apparatus 1100 for, in a Broadcast-and-Select, B&S, node, of transmitting a first optical signal, wherein the first optical signal is intended to be received at a plurality of B&S nodes.

### DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Aspects of the present disclosure provide methods and apparatuses (for example B&S node architectures) that enable traffic protection within a B&S network architecture on a bidirectional single fiber link. In particular, the methods and apparatuses described herein may avoid the need to duplicate nodes with the B&S network architecture in order to provide the traffic protection.

The provided methods and apparatuses are also compatible with optical amplification, which may be utilized to mitigate power losses that can be experienced with power splitter-based B&S node architectures.

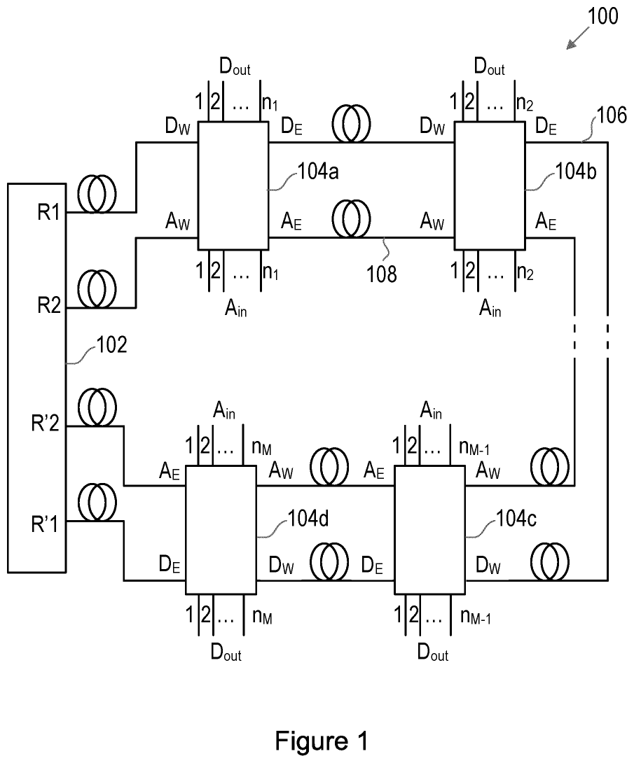

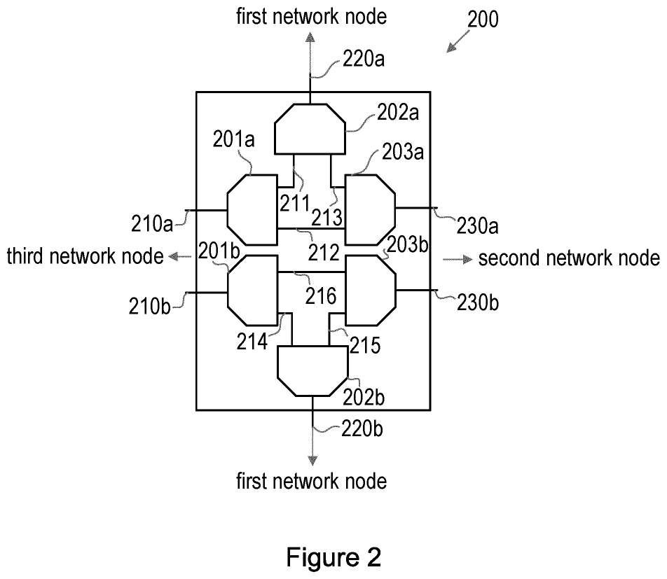

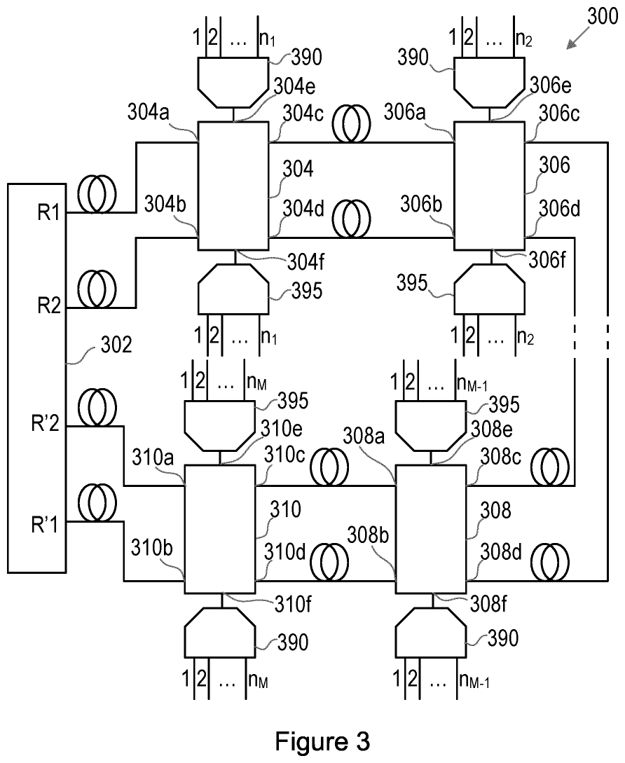

FIG. 2 illustrates an example of a Broadcast-and-Select, B&S, node 200. The B&S node 200 may be for use in a B&S network (for example the B&S network as described later with reference to FIG. 3). The B&S network may be structured similarly to the OADM network illustrated in FIG. 1 with a hub node configured to operate similarly to the hub node 102, but replacing the OADM nodes 104 with B&S nodes each, for example, comprising the structure of a first B&S node 200 described herein.

The B&S node 200 as described herein is therefore designed to provide traffic protection such that downstream signals received from either the first downstream port R1 or the second downstream port R′1 of the hub node can be received and appropriately routed by the first B&S node 200.

In this disclosure components may be described as being either “upstream” or “downstream”. The use of this terminology is simply to distinguish between those components that are utilized in the upstream capability of a B&S node or the downstream capability of a B&S node.

The B&S node 200 comprises a first downstream port 210a coupled to a first downstream power splitter/combiner 201a. The first B&S node 200 further comprises a second downstream port 220a coupled to a second downstream power splitter/combiner 202a. The first B&S node 200 further comprises a third downstream port 230a coupled to a third downstream power splitter/combiner 203a.

A first downstream optical signal may be received at the first downstream port 210a of the first B&S node 200, and may then transmitted to the first downstream power splitter/combiner 201a. The first downstream optical signal may be received from a third network node (e.g. another B&S node or a hub node).

The first downstream power splitter/combiner 201a is configured to split a total power of the first downstream optical signal received at the first downstream port 210a to form a first version and a second version of the first downstream optical signal. It will be appreciated that the frequency characteristics of the first downstream optical signal, the first version of the first downstream optical signal, and the second version of the first downstream optical signal may be substantially the same. In other words, the first power splitter is not intended to perform any wavelength selection when generating the first and second versions of the first downstream signal. For example, the first version and the second version of the first downstream optical signal may not comprise any different wavelength or frequency properties to the first downstream optical signal. It will be appreciated that, in some circumstances, some artifacts may be introduced by the components of the first B&S node 200 that may result in some slight differences in the wavelength and/or frequency properties of the first and/or second version of the first downstream signal when compared to the first downstream signal. However, these slight differences should still be considered as “substantially the same”, as described above.

In other words, the first and second versions of the first downstream signal are effectively copies of the first downstream optical signal each having a reduced total power compared to the first downstream optical signal. Where frequency characteristics of signals are described as being “substantially the same” herein, it will be appreciated that the above discussion will also apply.

The first version of the first downstream optical signal may then be transmitted to the second downstream power splitter/combiner 202a via a first connection 211. The first connection 211 couples the first downstream power splitter/combiner 201a to the second downstream power splitter/combiner 202a.

The second downstream power splitter/combiner 202a may transmit the first version of the first downstream optical signal to a first network node (e.g. a tail-end node), via the second downstream port 220a. In other words, the first version of the first downstream optical signal may be “dropped” to the first network node via the second downstream port 220a.

That is, in contrast to the OADM node described above with reference to FIG. 1, the first B&S node 200 performs no extraction of one or more wavelengths from a received optical signal when performing the “dropping”. Rather, the first B&S node 200 forms a reduced power version of the first downstream optical signal, and this version may then be transmitted (e.g. dropped) to the first network node by the first B&S node 200. The first network node may then be configured to select one or more relevant wavelengths from the received first version of the first downstream optical signal (for example, by means of a tunable filter).

The first downstream power splitter/combiner 201a of the first B&S node 200 is also coupled to the third downstream power/splitter combiner 203a via a second connection 212. The first downstream power splitter/combiner 201a may transmit the second version of the first downstream optical signal to the third downstream power splitter/combiner 203a via the second connection 212.

The third downstream power/splitter combiner 203a may then transmit the second version of the first downstream optical signal to a second network node via the third downstream port 230a. The second network node may comprise a further B&S node, or a hub node, as will be explained in greater detail with reference to FIG. 3.

That is, the first B&S node 200 is configured such that it may transmit the second version of the first downstream optical signal to the next node in a B&S network architecture, as well as dropping the first version of the first downstream optical signal, thereby propagating the data in the first downstream optical signal through the B&S network.

Therefore, the first B&S node may be positioned within a B&S network such that, the first downstream signal would have originated at a first downstream port R1 of the hub node (as described further with reference to FIG. 3).

In order to provide traffic protection, the first B&S node 200 is also configured such that a second downstream optical signal may be received at the third downstream port 230a and transmitted to the third downstream power splitter/combiner 203a. The second downstream optical signal may be received at the third downstream port 230a from the second network node.

The third downstream power splitter/combiner 203a may be configured to split a total power of the second downstream optical signal received at the third downstream port 230a to form a first version and a second version of the second downstream optical signal. Similarly to as described above, the frequency characteristics of the second downstream optical signal, the first version of the second downstream optical signal, and the second version of the second downstream optical signal may be substantially the same.

The first version of the second downstream optical signal may then be transmitted to the second downstream power splitter/combiner 202a via a third connection 213. The third connection 213 couples the third downstream power splitter/combiner 203a to the second downstream power splitter/combiner 202a.

The second downstream power splitter/combiner 202a may then transmit the first version of the second downstream optical signal to the first network node (e.g. a tail end node), via the second downstream port 220a. In other words, the first version of the second downstream optical signal may be “dropped” at the first network node via the second downstream port 220a.

The third downstream power splitter/combiner 203a may transmit the second version of the second downstream optical signal to the first downstream power splitter/combiner 201a via the second connection 212. The first downstream power/splitter combiner 201a may then transmit the second version of the second downstream optical signal to the third network node, via the first downstream port 310a. As previously mentioned, the third network node may comprise an additional B&S node, or a hub node, as will be explained in greater detail with reference to FIG. 3.

It will therefore be appreciated that both the first downstream port 210a and the third downstream port 230 may be utilized as input ports or output ports depending on whether the B&S node is receiving the first downstream optical signal or the second downstream optical signal.

That is, the first B&S node 200 is structured such that, regardless of whether the first B&S node 200 receives the first downstream optical signal at the first downstream port 210a or the second downstream optical signal at the third downstream port 230a, two versions are formed of the received downstream optical signal. The structure of the first B&S node 200 will then automatically drop one of the versions of the received downstream optical signal at the first network node, the other version of the received downstream optical signal is able automatically transmitted another node (either the second network node or the third network node) in the B&S network architecture (as will be described with greater reference to FIG. 3).

It will be appreciated that in this illustrated embodiment, it is the aforementioned first B&S node 200 architecture that enables this functionality to be executed in a passive or automatic manner. That is, there is no need to inform the first B&S node 200 as to whether it will receive the first downstream optical signal or the second downstream optical signal in order to execute the aforementioned functionality.

The first B&S node 200 further comprises a first upstream port 210b coupled to a first upstream power splitter/combiner 201b. The first B&S node 200 further comprises a second upstream port 220b coupled to a second upstream power splitter/combiner 202b. The first B&S node 200 further comprises a third upstream port 230b coupled to a third upstream power splitter/combiner 203b.

A first upstream optical signal may be received at the second upstream port 220b of the first B&S node 200, and transmitted to the second upstream power splitter/combiner 202b. The second upstream power splitter/combiner 202b may then be configured to split a total power of the first upstream optical signal received at the second upstream port 220b to form a first version and a second version of the first upstream optical signal. Similarly to as described above, the frequency characteristics of the first upstream optical signal, the first version of the first upstream optical signal, and the second version of the first upstream optical signal may be substantially the same.

The first version of the first upstream optical signal may then be transmitted to the first upstream power splitter/combiner 201b via a fourth connection 214. The fourth connection 214 couples the first upstream power splitter/combiner 201b to the second upstream power splitter/combiner 202b.

The first power splitter/combiner 201b may then transmit the first version of the first upstream optical signal to the third network node, via the second upstream port 210b.

The second upstream power splitter/combiner 202b is also coupled to the third upstream power/splitter combiner 203b via a fifth connection 215. The second upstream power splitter/combiner 202b may transmit the second version of the first upstream optical signal to the third upstream power splitter/combiner 203b via the fifth connection 215.

The third power/splitter combiner 203b may transmit the second version of the first upstream optical signal to the second network node, via the third upstream port 230b. The first upstream power splitter/combiner 201b is also coupled to the third upstream power/splitter combiner 203b via a sixth connection 216.

In some embodiments, the first upstream power splitter/combiner 201b may be configured to transmit the first version of the first upstream signal by adding the first version of the first upstream optical signal to a second upstream optical signal received from the third upstream power/splitter combiner 203b (if any signal is received from the third upstream power/splitter combiner) to generate an updated second upstream optical signal. The second upstream optical signal may be received at the first upstream power splitter/combiner 201b from the third upstream power/splitter combiner 203b via the sixth connection 216. The first upstream power splitter/combiner 201b may then be configured to transmit the updated second upstream optical signal to the third network node, via the first upstream port 210b.

In some embodiments, the third upstream power splitter/combiner 203b is configured to add the second version of the first upstream optical signal to a third upstream optical signal received from the first upstream power/splitter combiner 201b to generate an updated third upstream optical signal. The third upstream optical signal may be received from the first upstream power/splitter combiner 201b via the sixth connection 216. The third upstream power splitter/combiner 201b may then be configured to transmit the updated third upstream optical signal to the second network node, via the third upstream port 230b.

In other words, the first B&S node 200 may additionally be configured to form two versions of the first upstream optical signal, and may then transmit these two versions of the first upstream optical signal to two different nodes (e.g. the second network node and the third network node) respectively within a B&S network architecture (as will be described with greater reference to FIG. 3). It will again be appreciated that the aforementioned B&S node architecture enables this aforementioned functionality to be executed in a passive manner.

It will also be appreciated that the first B&S node 300 described above may be configured as two separate B&S nodes, one comprising the aforementioned upstream ports, upstream power splitters/combiners and first, second and third connections, and the other comprising the aforementioned downstream ports, downstream power splitters/combiners, and fourth, fifth and sixth connections, respectively. Each B&S node (for example, in some embodiments the second network node and the third network node) in the B&S network may also be separated into two physical nodes.

An example of how the aforementioned first B&S node 200 may be implemented in a B&S network is now described.

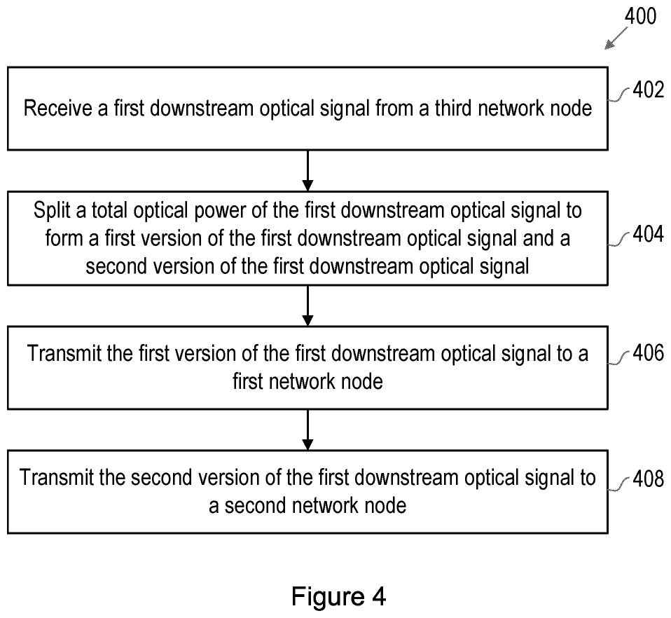

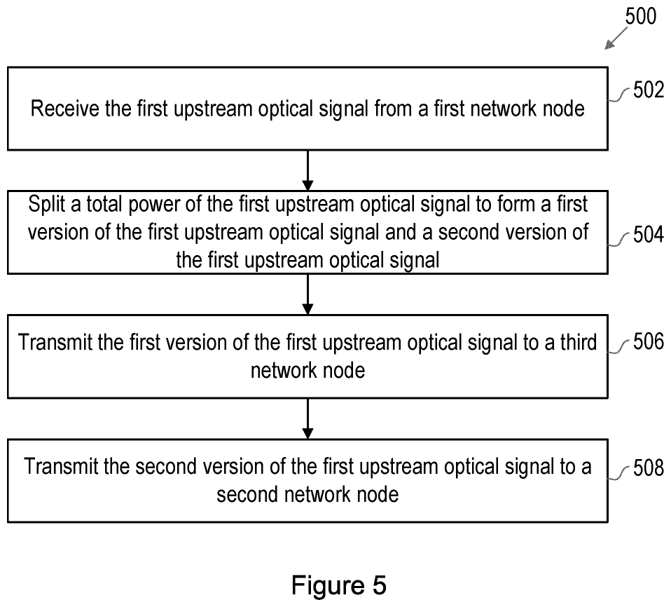

FIG. 3 illustrates an example B&S network architecture 300. The functionality of this B&S network architecture 300 will be described with reference to the methods illustrated in FIGS. 4 and 5. FIG. 4 illustrates a flowchart of a method 400 of dropping a downstream optical signal at a B&S node, wherein the downstream optical signal is intended to be received at a plurality of B&S nodes. FIG. 5 illustrates a flowchart of a method 500, in a B&S node, of transmitting a first upstream optical signal, wherein the first upstream optical signal is intended to be received at a plurality of B&S nodes.

The B&S network 300 comprises a hub node 302, and four B&S nodes 304, 306, 308 and 310 arranged in a ring configuration with the hub node 302. Similarly to as described with reference to FIG. 1, the ring configuration comprises a downstream fiber ring coupled between a first downstream port R1 and a second downstream port R′1 of the hub node 302, and an upstream fiber ring coupled between a first upstream port R2 and a second upstream port R′2 of the hub node 302.

It will be appreciated that the B&S network architecture 300 may be extended to comprise any suitable number of B&S nodes. It will also be appreciated that any one of the four illustrated B&S nodes 304, 306, 308 and 310 may comprise the architecture of the first B&S node 200 as described with reference to FIG. 2.

Each B&S node 3xx (i.e. 304, 306 308 or 310) comprises 6 ports 3xxa to 3xxf. The ports 3xxa correspond to the first downstream port 210a as described with reference to FIG. 2. The ports 3xxb correspond to the first upstream port 210b as described with reference to FIG. 2. The ports 3xxc correspond to the third downstream port 230a as described with reference to FIG. 2. The ports 3xxd correspond to the third upstream port 230b as described with reference to FIG. 2. The ports 3xxe correspond to the second downstream port 220a as described with reference to FIG. 2. The ports 3xxf correspond to the second upstream port 220b as described with reference to FIG. 2.

Therefore, for example, for the B&S node 304, the second network node comprises the B&S node 306, and the third network node comprises the hub node 302. In a similar way, for the B&S node 306, the second network node comprises the B&S node 308 and the third network node comprises the B&S node 304. The same logic may be applied to each B&S node in the B&S network architecture 300.

In a similar way to as described with reference to FIG. 1, the B&S network architecture 300 may operate in two different modes of operation. A working mode of operation may be used when no faults are detected in the B&S network architecture 300. A protection mode of operation may be used when a fault is detection in the B&S network architecture 300.

In the working operation of the B&S network architecture 300, a first downstream optical signal is generated at the hub node 302, and is transmitted via the first downstream port R1 of the hub node 302 to the first downstream port 304a of the B&S node 304 via the downstream optical fiber ring.

That is, as illustrated in step 402 of FIG. 4, the B&S node 304 receives a first downstream optical signal from a third network node 302 (in this example, the hub node 302), for example at the first downstream port 304a.

As described in step 404 of FIG. 4, the B&S node 304 splits a total optical power of the first downstream optical signal to form a first version of the first downstream optical signal and a second version of the first downstream optical signal. As previously described the frequency characteristics of the first downstream optical signal, the first version of the first downstream optical signal, and the second version of the first downstream optical signal may be substantially the same.

It will be appreciated that the first version and the second version of the first downstream optical signal may be generated by the architecture of the B&S node 304 as illustrated in FIG. 2.

At step 406, the B&S node 304 transmits the first version of the first downstream optical signal to a first network node. That is, the B&S node 304 “drops” the first version of the first downstream optical signal at the first network node via the second downstream port 304e.

The B&S network architecture 300 may then further comprise a fourth power splitter/combiner 390 configured to receive the signal output by the second downstream port 304e. The functionality of the fourth power splitter/combiner 390 will be described in more detail later. The first network node may then select one or more required wavelengths from the first version of the first downstream optical signal (e.g. as output by the fourth power splitter/combiner).

At step 408, the B&S node 304 transmits the second version of the first downstream optical signal to a second network node 306 (in this example the B&S node 306), for example, via the third downstream port 304c.

It will be appreciated that the second version of the first downstream optical signal that is transmitted to the B&S node 306 will then become the first downstream optical signal that is received at the first downstream port 306a of the B&S node 306.

It will be appreciated that the aforementioned method of FIG. 4 may then be repeated for each of the B&S nodes 306, 308 and 310 in the downstream fiber ring of the B&S network 300 (where the second version of the first downstream optical signal that is transmitted from the B&S node 310 will be received at the R′1 port of the hub node 302). The version of the first downstream optical signal that is then received at the hub node 302 may then be stopped by an isolator, for example. In this illustrated embodiment, it will be appreciated that, each of the plurality of B&S nodes 304, 306, 308 and 310 in the B&S network architecture 300, in the aforementioned working mode of operation, will receive a downstream optical signal at the first downstream port 3xxa, and transmit a version of the received downstream optical signal (with reduced power) from the third downstream port 3xxc.

During the working mode of operation, the aforementioned B&S network 300 therefore enables the data in the downstream signal transmitted from R1 to be propagated through the whole B&S network by transmitting reduced power versions of the signals received at each B&S node to the next node in the B&S network 300, as well as enabling the data in the downstream signal transmitted from R1 to be dropped at a first network node. It will therefore be appreciated that each B&S node 3xx (i.e. 304, 306 308 or 310) comprised within the B&S network 300 is respectively configured to receive the first downstream optical signal responsive to no fault occurring in the entire B&S network 300.

The B&S network 300 may begin operating in a protection mode of operation under certain circumstances. For example, the B&S network 300 may enter the protection mode of operation when a fiber connection between two consecutive B&S nodes in the fiber ring fails (for example, when the fiber connection between the third downstream port 306c of the B&S node 306, and the first downstream port 308a of the third B&S node 308 fails). In most circumstances, when the fiber connection in the upstream or downstream fiber ring fails, the other of the upstream of downstream fiber ring is also likely to fail in the same position due to the typical containment of both fibers within the same sheath. However, it will be appreciated that, in some circumstances, it is possible for a failure to occur in only one of the upstream or downstream fiber rings.

When the B&S network 300 is operating in protection mode, the hub node 302 may generate two copies of the downstream optical signal, a first downstream optical signal, and a second downstream optical signal. The hub node 302 may then transmit the first downstream optical signal from the first downstream port R1 and transmit the second downstream optical signal from the second downstream port R′1.

Considering the situation in which the fiber connection between the third downstream port 306c of the B&S node 306, and the first downstream port 308a of the B&S node 308, has failed, it will be appreciated that the B&S node 304 and B&S node 306 will receive the data originating from the first downstream optical signal transmitted from R1 in the same manner as described above. It will therefore be appreciated that each B&S node 3xx (i.e. 304, 306 308 or 310) comprised within the B&S network 300 is respectively configured to receive the first downstream optical signal responsive to no fault occurring between a first downstream port R1 of the hub node 302 in the B&S network 300, and the first downstream port 3xxa of the B&S node 3xx.

However, as the connection between third downstream port 306c of the B&S node 306 and the first downstream port 308a of the B&S node 308 has failed, the B&S node 308 is now unable to receive a version of the first downstream optical signal at its first downstream port 308a (as it would have been able to prior to the connection failure). The B&S node 310 will also therefore not receive a version of the first downstream optical signal as transmitted from R1.

Now referring to the second downstream optical signal transmitted from the second downstream port R′1 of the hub node 302. The B&S node 310 is configured such that the second downstream optical signal may be received at the third downstream port 310c of the B&S node 310.

The B&S node 310 will then split a total optical power of the second downstream optical signal to form a first version of the second downstream optical signal and a second version of the second downstream optical signal. As previously described, the frequency characteristics of the second downstream optical signal, the first version of the second downstream optical signal, and the second version of the second downstream optical signal may be substantially the same.

The B&S node 310 may then transmit the first version of the second downstream optical signal to a first network node (e.g. a tail end node), for example, via the second downstream port 310e.

In this illustrated embodiment, the first network node coupled to the B&S node 310 then selects one or more relevant wavelengths from the first version of the second downstream optical signal.

In this illustrated embodiment, each second downstream port 3xxe of each respective B&S node is coupled to a fourth power splitter/combiner 390 that is configured to separate a third downstream optical signal output by the second downstream port 3xxe into a predetermined number of optical signals (which may be different for each B&S node in the B&S network 300), wherein the third downstream optical signal is based on either the first version of the first optical signal or the first version of the second optical signal (depending on which signal is being received by the relevant B&S node). That is, the fourth power splitter/combiner 390 splits a total optical power of the third downstream optical signal into a predetermined number of optical signals.

In some embodiments, the fourth power splitter/combiner 390 may act as a spatial multiplexer/demultiplexer for the first network node. In some embodiments, the fourth power splitter/combiner 390 may comprise a 1:N power splitter/combiner, where the value of N corresponds to a splitting ratio of the fourth power splitter/combiner 390. In this illustrated embodiment, a number of wavelengths M that may possibly be received at the first network node is equal to the value of N. In some embodiments, a tuneable filter (or receiver) at the first network node may then be adjusted to receive a particular wavelength from each of the outputs of the fourth power splitter/combiner 390 respectively.

In some embodiments, the number of wavelengths M that may possibly be received at the first network node may be greater that the value of N. This may be the case in certain embodiments in which insertion loss induced by the fourth power splitter/combiner 390 is to be limited. In some embodiments, the number of wavelengths M that may possibly be received at the network node may be less than the value of N. This may be utilized in certain embodiments in which it is possible that, in the future, the first network node may be required to receive a greater number of wavelengths.

The B&S node 310 may then transmit the second version of the second downstream optical signal to a second network node (e.g. B&S node 308), for example, via the first downstream port 310a.

It will be appreciated that the second version of the second downstream optical signal that is transmitted to the B&S node 308 will then become the second downstream optical signal that is received at the third downstream port 308c of the B&S node 308.

It will therefore be appreciated that each B&S node 3xx (i.e. 304, 306 308 or 310) comprised within the B&S network 300 is respectively configured to receive the second downstream optical signal responsive to a fault occurring between the first downstream port R1 of the hub node 302 and the first downstream 3xxa port of the B&S node 3xx.

That is, in the aforementioned protection mode, the B&S node 308 and B&S node 310 will receive a downstream optical signal at a their third downstream ports 3xxc, and will transmit a version of the received downstream optical signal from their first downstream ports 3xxa.

By transmitting copies of the downstream signal from both R1 and R′1, the protection mode of operation ensures that the relevant data is received at all of the plurality of B&S nodes 304, 306, 308, 310 in the B&S network 300 either at their first downstream port 3xxa or at their third downstream port 3xxc.

Regardless of which port a B&S node receives a downstream signal at, it is configured to: form two version of the received downstream signal, drop one version at a first network node (e.g. a tail end node), for example via the second downstream port 3xxe, and the propagate the other version on to another node in the B&S network.

As noted above, this functionality may be executed passively (or automatically) by the B&S node, enabling the B&S network 300 to work effectively even when a fault has occurred. It will also be appreciated that, as each B&S node respectively drops a version of the downstream signal that was originally transmitted by the hub node 302, there is no complexity introduced by any requirement to drop specific wavelengths at any particular B&S node within the network 300.

The upstream capability of the B&S network 300 will now be described with reference to the method of FIG. 5.

Firstly, the working operation of the B&S network 300 in the upstream direction will be described.

At step 502 the B&S node 306 receives a first upstream optical signal from a first network node, for example at the second upstream port 306f of the B&S node 306.

In some embodiments, the first upstream optical signal may be formed based on one or more partial optical signals received from the first network node. For example, the first network node may comprise a tunable transmitter that is configured to output the one or more partial optical signals. The one or more partial optical signals may then be combined by a fifth power splitter/combiner 395 to generate the first upstream optical signal.

At step 504, the B&S node 306 splits a total power of the first upstream optical signal to form a first version of the first upstream optical signal and a second version of the first upstream optical signal. As previously described, the frequency characteristics of the first upstream optical signal, the first version of the first upstream optical signal, and the second version of the first upstream optical signal may be substantially the same.

At step 506, the B&S node 306 transmits the first version of the first upstream optical signal to a third network node (in this example, the B&S node 304), for example, via the first upstream port 306b.

At step 508, the B&S node 306 transmits the second version of the first upstream optical signal to a second network node (in this example, the B&S node 308), for example, via the third upstream port 306d.

It will be appreciated that the first and second versions of the first upstream optical signal may be generated and transmitted by the architecture of the B&S node 306 as described with reference to FIG. 2.

That is, the B&S node 306 is configured to form two versions of the first upstream optical signal, and then respectively transmit each of these versions to two different nodes within the B&S network 300. As previously noted, the aforementioned structure of the B&S node 200 enables this functionality to be performed in a passive manner.

It will be appreciated that the first version of the first upstream optical signal that arrives at the third upstream port 304d of the B&S node 304 will become a second upstream optical signal that is received at the B&S node 304. It will be appreciated that the first B&S node will also be configured to receive its own first upstream optical signal from a first network node (e.g. a tail end node), for example at the second upstream port 304f, and will split a total power of the first upstream optical signal in the same manner as described for the B&S node 306.

It will be appreciated that (for example as described with reference to FIG. 2) the B&S node 304 is configured to add the second upstream optical signal received at the third upstream port 304d to the first version of the first upstream optical signal received at the second upstream port 304f to generate an updated second upstream optical signal. B&S node 304 will then transmit the updated second upstream optical signal to the hub node 302, via the first upstream port 304b. That is, the B&S node 304 is configured to: add the first version of the first upstream optical signal to the second upstream optical signal to generate an updated second upstream optical signal; and transmit the updated second upstream optical signal to a third network node (in this example, the hub node 302).

In a similar manner, it will be appreciated that the second version of the first upstream optical signal that arrives at the first upstream port 308b of the B&S node 308 will become a third upstream optical signal received by the third B&S node 308. It will be appreciated that the third B&S node 308 will be configured to receive its own first upstream optical signal from a first network node (e.g. a tail end node) for example, at the second upstream port 308f, and will split a total power of the first upstream optical signal in the same manner as described above for the B&S node 306.

It will be appreciated (for example as described with reference to FIG. 2) the B&S node 308 is configured to add the second version of the first upstream optical signal received at the second upstream port 308f to the third upstream optical signal received at the first upstream port 308b to generate an updated third upstream optical signal. The B&S node 308 adds the second version of the first optical signal to the third upstream optical signal to generate an updated third upstream optical signal, and transmits the updated third upstream optical signal to a third network node (in this example, B&S node 310).

Each B&S node is therefore configured to be able to receive upstream optical signals at both the first upstream port 3xxb and the second upstream port 3xxd (although it will be appreciated that, in the illustrated B&S network 300, B&S node 304 receives no signal at the first upstream port 304b, and B&S node 310 receives no signal at the third upstream port 310d). Each B&S node will then add a version of the first upstream signal to respectively to each of the received upstream signals, and will transmit the resulting updated upstream signals on to another node in the B&S network, in the opposite direction from which they arrived. The upstream capability of the B&S node is therefore bi-directional.

It will therefore be appreciated that, in a working mode of operation of the B&S network 300, two copies of the same final upstream optical signal will respectively arrive at the first upstream port R2 and the second upstream port R′2 of the hub node 302. The hub node 302 may then determine which received upstream optical signal is to be transmitted to one or more respective receivers.

As noted above, the B&S network 300 may enter protection mode of operation when a fiber connection between two consecutive B&S nodes in the fiber ring fails (for example, when the fiber connection between the third upstream port 306d of the B&S node 306, and the first upstream port 308b of the B&S node 308 fails).

Consider a situation in which the fiber connection between the third upstream port 306d of the B&S node 306, and the first upstream port 308b of the B&S node 308 has failed. A first version of the first upstream optical signal received at the second upstream port 306f of B&S node 306 will arrive at the first upstream port R2 of the hub node 302.

However, as the aforementioned fiber connection is broken, the B&S node 306 will not receive a second upstream optical signal at its third upstream port 306d from the B&S node 308. Therefore final optical signal that will arrive at the first upstream port R2 of the hub node 302 will only be based on the first upstream optical signals received at the B&S node 304 and the B&S node 306 (which may still be transmitted along the unbroken fiber connection between the first upstream port R2 and the B&S node 306 in accordance with the method described above).

Similarly, a final upstream optical signal will arrive at the second upstream port R′2 of the hub node 302. However, as the aforementioned fiber connection is broken, the B&S node 308 will not receive a third upstream optical signal at its first upstream port 308b from the B&S node 306. Therefore, the final upstream optical signal that will arrive at the second upstream port R′2 of the hub node 302 will only be based on the first upstream optical signals received at the B&S node 308 and the B&S node 310 (which may still be transmitted along the unbroken fiber connection between the second upstream port R′2 and the B&S node 308 in accordance with the method described above).

That is, in contrast to the working mode of operation, in the protection mode of operation, the hub node 302 will receive a first part (as opposed to a first copy) of a total upstream signal at the first upstream port R2 of the hub node 302, and will receive a second part (as opposed to a second copy) of the total upstream signal at the second upstream port R′2 of the hub node 302. The hub node 302 may then form a total upstream signal based on the received first and second parts of the total upstream signal.

As previously noted, the aforementioned B&S node architecture described with reference to FIG. 2 may enable this functionality of the B&S nodes to be executed in a passive manner, and therefore allows the B&S network 300 to effectively transmit an upstream signal to the hub node 302, even when a fault has occurred in the network 300.

It will be appreciated that the first network nodes operating as tail-end nodes may comprise a number of different types of nodes. For example, in an example in which the B&S network is implemented in a fronthaul network of a radio access network, the first network nodes may comprise radio cells. In some examples, the nodes may handle radio data, for example, in the form of eCPRI or CPRI. For example, the first network nodes may comprise any suitable form of switch (e.g. a packet switch, OTN switch, TDM switch etc.) and a transceiver.

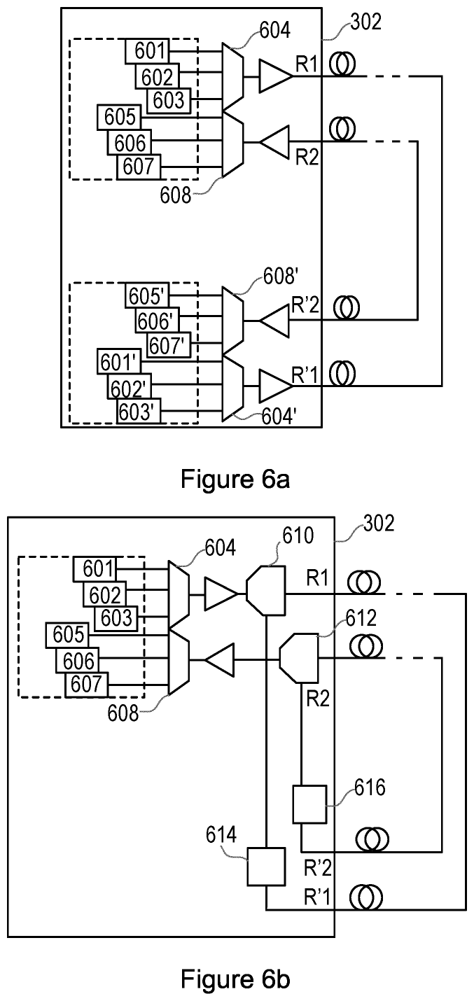

Two implementations of a hub node 302 that may implement a protection mode in the B&S network 300 are now described with reference to FIG. 6a and FIG. 6b respectively.

FIG. 6a illustrates a 1+1 protection scheme implemented in a hub node 302. In the 1+1 protection scheme, three transmitters 601, 602, 603 that are respectively coupled to a multiplexer 604 that is coupled to the first downstream port R1, and three receivers 605, 606, 607 that are respectively coupled to a demultiplexer 608 that is coupled to the first upstream port R2, have been duplicated. That is, three additional transmitters 601′, 602′, 603′ are respectively coupled to a multiplexer 604′ that is coupled to the second downstream port R′1, and three additional receivers 605′, 606′, 607′ are respectively coupled to a demultiplexer 608′ that is coupled to the second upstream port R′2. The intelligence of the hub node 302 may then activate the 1+1 protection scheme when a fault occurs in the network 100 (for example, when a fiber break in the fiber ring occurs) by transmitting the same downstream signals from the pairs of transmitters (e.g. 601 and 601′, 602 and 602′ etc).

FIG. 6b illustrates a 1:1 protection scheme implemented in a hub node 302 (similar components have been given similar reference numbers to those in FIG. 6a). In the 1:1 protection scheme, a first power splitter/combiner 610 is disposed between the first downstream port R1, and the multiplexer 604. Additionally, a second power splitter/combiner 612 is disposed between the first upstream port R2, and the demultiplexer 608. The first power splitter/combiner 610 is coupled to a first fiber switch 614, which is coupled to the second downstream port R′1. The second power splitter/combiner 612 is coupled to a second fiber switch 616, which is coupled to the second upstream port R′2.

In a working mode of a network (for example, the network 100), the first fiber switch 614 and the second fiber switch 616 are open, and the respective downstream and upstream signals are transmitted (from R1) and received (at R2) in accordance with the operation described above. In a protection mode of the network, the first fiber switch 614 and the second fiber switch 616 closed. As such, two copies of the downstream signal will be transmitted, one via the first downstream port R1, and the other via the second downstream port R′1. Additionally, in accordance with the operation described above, a first part of the total upstream signal will be received at the first upstream port R2, and a second part of the total upstream signal will be received at the second upstream port R′2. The second power splitter/combiner 612 may then receive and combine both the first and second parts of the total upstream signal, and may then transmit the total upstream signal to the demultiplexer 608.

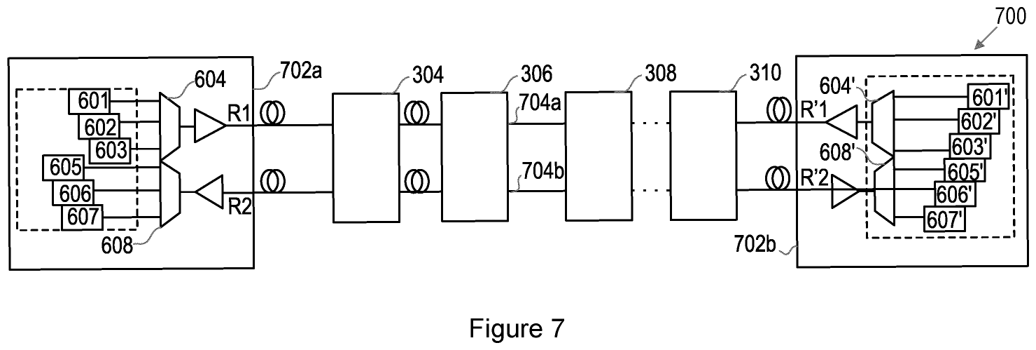

FIG. 7 illustrates an alternative B&S network architecture 700. It will be appreciated that the network 700 is able to implement the same working and protection modes as described with reference to FIG. 3 above, and comprises the B&S nodes 304, 306, 308 and 310 as described with reference to FIG. 3 above.

FIG. 7 illustrates a dual homing network infrastructure. In this illustrated infrastructure, two hub nodes 702a and 702b are placed at the ends of the upstream and downstream fiber chains 704a and 704b. It will be appreciated that this introduction of two hub nodes 702a and 702b can be considered equivalent to splitting the hub node 302 described above, such that the first upstream port R2 and the first downstream port R1 are comprised at the first hub node 702a, and the second upstream port R′2 and the second downstream port R′1 are comprised at the second hub node 702b. That is, FIG. 7 illustrates and alternative implementation of the 1+1 protection scheme as illustrated in FIG. 6a.

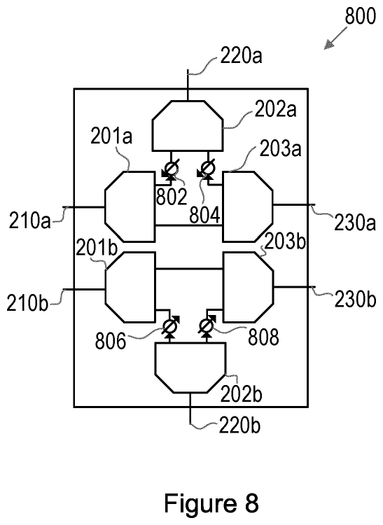

FIG. 8 illustrates a second B&S node 800. Elements of the B&S node 800 that correspond to elements of the B&S node 200 shown in FIG. 2 are indicated by the same reference numerals, and are not described further herein.

The B&S node 800 comprises a first downstream variable attenuator 802 disposed between and respectively coupled to the first downstream power splitter/combiner 201a, and the second downstream power splitter/combiner 202a. The first downstream variable attenuator 802 is configured to variably adjust an optical power level of the first version of the first downstream optical signal prior to the receipt of the first version of the first downstream optical signal by the second power splitter/combiner 202a. That is, prior to transmitting the first version of the first downstream optical signal to a first network node, the second B&S node 800 may adjust an optical power level of the first version of the first downstream optical signal.

The B&S node 800 further comprises a second downstream variable attenuator 804 disposed between and respectively coupled to the third downstream power splitter/combiner 203a, and the second downstream power splitter/combiner 202a. The second downstream variable attenuator 804 is configured to variably adjust an optical power level of the first version of the second downstream optical signal prior to the receipt of the first version of the second downstream optical signal by the second downstream power splitter/combiner 202a. That is, prior to transmitting the first version of the second downstream optical signal to the first network node, the B&S node 800 may adjust an optical power level of the first version of the second downstream optical signal.

In this example, the B&S node 800 further comprises a first upstream variable attenuator 806 disposed between and respectively coupled to the first upstream power splitter/combiner 201b, and the second upstream power splitter/combiner 202b. The first upstream variable attenuator 806 is configured to adjust an optical power level of the first version of the first upstream optical signal prior to the receipt of the first version of the first upstream optical signal by the first upstream power splitter/combiner 201b. That is, prior to transmitting the first version of the first upstream optical signal, the B&S node 800 may adjust an optical power level of the first version of the first upstream optical signal.

The B&S node 800 further comprises a second upstream variable attenuator 808 disposed between and respectively coupled to the third upstream power splitter/combiner 203b, and the second upstream power splitter/combiner 202b. The second upstream variable attenuator 808 is configured to adjust an optical power level of the second version of the first upstream optical signal prior to the receipt of the second version of the first optical signal by the third upstream power splitter/combiner 203b. That is, prior to transmitting the second version of the first upstream optical signal, the second B&S node 800 may adjust an optical power level of the second version of the first upstream optical signal.

It will be appreciated that this dynamic attenuation may be utilized in response to a network (in which the B&S node 800 is comprised) experiencing a fault and/or entering protection mode. That is, this variable attenuation may be utilized in response to the expected number of intermediate over which an optical signal is to be transmitted before reaching the hub node or the first network node changing. For example, considering the network 300 described above, if a fault were to occur in the fiber connection between the third downstream port 308c of the B&S node 308, and the first downstream port 310a of the B&S node 310, it will be appreciated that the first network node connected to the second downstream port 310e of the B&S node 310 may be configured to receive signal having relatively low total power (as the downstream optical signal will have first been propagated through, and power split by, the B&S nodes 304, 306 308 and 310). If the system were then to enter protection mode, it will be appreciated that a first version of the second downstream signal would be received by the first network node connected to the second downstream port 310e (where the second downstream signal has been transmitted directly from the hub node 302 to the B&S node 310) might be of a relatively higher total power. Therefore, in this example, the second variable attenuator 804 may be configured to provide more attenuation in response to the fault occurring. In some embodiments, the adjustments of how much attenuation should be applied by each attenuator may be based on a power level of a respective signal that has been added or dropped at a second port of the second B&S node 800. For example, the attenuation may be applied in such a way so as to achieve a desired power level for the signals output by the attenuators.

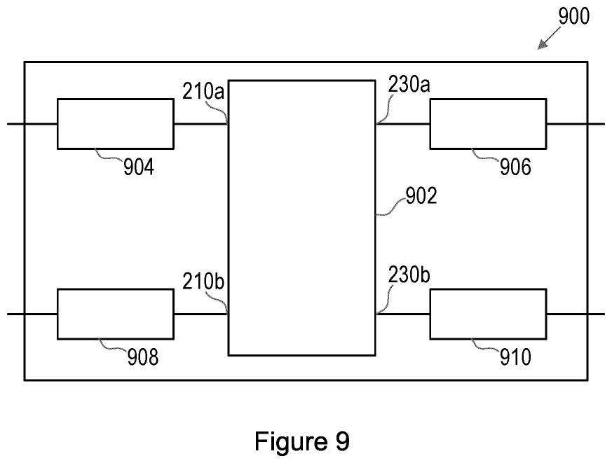

FIG. 9 illustrates an extended B&S node system 900. The extended B&S node system 900 comprises a B&S node 902, that may comprise the B&S node 200 described with reference to FIG. 2, or the B&S node 800 described with reference to FIG. 8, above.

The extended B&S node system 900 further comprises a first variable bidirectional amplifier 904 that is coupled to the first downstream port 210a of the third B&S node 902. The first variable bidirectional amplifier 904 is configured to variably amplify the first downstream optical signal, and to variably amplify the second version of the second optical signal described above. That is, the extended B&S node system 900 may variably amplify the first downstream optical signal, or variably amplify the second version of the second downstream optical signal, for example, depending on whether the B&S node 902 is receiving the first downstream optical signal or the second downstream optical signal.

The extended B&S node system 900 further comprises a second variable bidirectional amplifier 906 that is coupled to the third downstream port 230a of the B&S node 902. The second variable bidirectional amplifier 906 is configured to variably amplify the second downstream optical signal, or to variably amplify the second version of the first downstream optical signal described above. That is, the extended B&S node system 900 may variably amplify the second downstream optical signal, or variably amplify the second version of the first downstream optical signal, for example, depending on whether the B&S node 902 is receiving the first downstream optical signal or the second downstream optical signal.

The extended B&S node system 900 further comprises a first variable directional amplifier 908 that is coupled to the first upstream port 210b of the B&S node 902. The first variable directional amplifier 908 is configured to variably amplify the updated second upstream optical signal described above. That is, the extended B&S node system 900 may variably amplify the updated second upstream optical signal.

The extended B&S node system 900 further comprises a second variable directional amplifier 910 that is coupled to the third upstream port 230b of the B&S node 902. The second variable directional amplifier 910 is configured to variably amplify the updated third upstream optical signal described above. That is, the third B&S node 900 may variably amplify the updated third upstream optical signal.

It will be appreciated that a variable bidirectional amplifier may therefore amplify a signal that is traveling in either direction along a bidirectional fiber, whereas a variable directional amplifier may only amplify a signal travelling in one particular direction along a bidirectional fiber. In this illustrated embodiment, the first 908 and second 910 directional amplifiers are configured to only amplify the updated upstream signals that are formed at the B&S node 902. It will be appreciated that the aforementioned bidirectional and/or directional amplifiers may be implemented in order to counteract insertion losses introduced by the aforementioned power splitter/combiner B&S architecture (it will be appreciated that, in the embodiments described herein, each copy of a downstream optical signal that is formed will comprise half the total power of the downstream optical signal from which the copy has been formed).

Additionally, the aforementioned bidirectional and/or directional amplifiers may be configured to variably amplify the aforementioned signals to provide a maximum power for the aforementioned signals that does not cause back scattering within the B&S network (for example, the B&S network 300). Additionally or alternatively, the aforementioned bidirectional and/or directional amplifiers may be configured to variably amplify the aforementioned signals in response to B&S nodes being added to or excluded from a B&S network (for example, the B&S network 300).

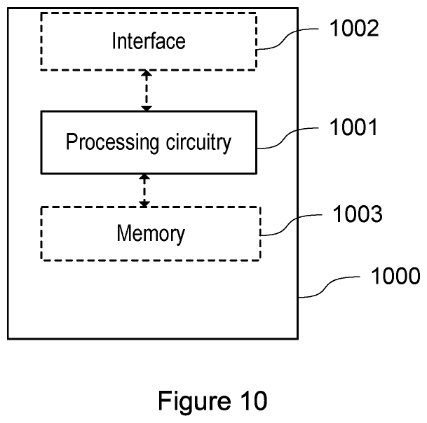

FIG. 10 illustrates a B&S node 1000 comprising processing circuitry (or logic) 1001. The processing circuitry 1001 controls the operation of the B&S node 1000 and can implement the method described herein in relation to a B&S node 1000. In particular, the processing circuitry 1001 may be configured to cause the B&S node 1000 to perform a method as described herein relating to the downstream capability of a B&S node. The processing circuitry 1001 can comprise one or more processors, processing units, multi-core processors or modules that are configured or programmed to control the B&S node 1000 in the manner described herein. In particular implementations, the processing circuitry 1001 can comprise a plurality of software and/or hardware modules that are each configured to perform, or are for performing, individual or multiple steps of the method described herein in relation to the B&S node 1000.

Briefly, the processing circuitry 1001 of the B&S node 1000 is configured to: receive a first downstream optical signal from a third network node; split a total optical power of the first downstream optical signal to form a first version of the first downstream optical signal and a second version of the first downstream optical signal; transmit the first version of the first downstream optical signal to a first network node; and transmit the second version of the first downstream optical signal to a second network node.

In some embodiments, the B&S node 1000 may optionally comprise a communications interface 1002. The communications interface 1002 of the B&S node 1000 can be for use in communicating with other nodes, such as other virtual nodes. For example, the communications interface 1002 of the B&S node 1000 can be configured to transmit to and/or receive from other nodes requests, resources, information, data, signals, or similar. The processing circuitry 1001 of B&S node 1000 may be configured to control the communications interface 1002 of the B&S node 1000 to transmit to and/or receive from other nodes requests, resources, information, data, signals, or similar.

Optionally, the B&S node 1000 may comprise a memory 1003. In some embodiments, the memory 1003 of the B&S node 1000 can be configured to store program code that can be executed by the processing circuitry 1001 of the B&S node 1000 to perform the method described herein in relation to the B&S node 1000. Alternatively or in addition, the memory 1003 of the B&S node 1000, can be configured to store any requests, resources, information, data, signals, or similar that are described herein. The processing circuitry 1001 of the B&S node 1000 may be configured to control the memory 1003 of the B&S node 1000 to store any requests, resources, information, data, signals, or similar that are described herein.

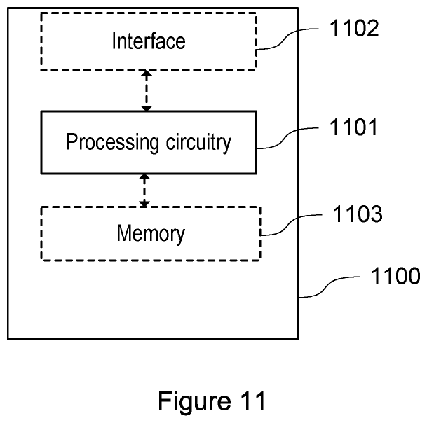

FIG. 11 illustrates a B&S node 1100 comprising processing circuitry (or logic) 1101. The processing circuitry 1101 controls the operation of the B&S node 1100 and can implement the method described herein in relation to a B&S node 1100. In particular, the processing circuitry 1101 may be configured to cause the B&S node 1100 to perform a method as described herein relating to the upstream capability of a B&S node. The processing circuitry 1101 can comprise one or more processors, processing units, multi-core processors or modules that are configured or programmed to control the B&S node 1100 in the manner described herein. In particular implementations, the processing circuitry 1101 can comprise a plurality of software and/or hardware modules that are each configured to perform, or are for performing, individual or multiple steps of the method described herein in relation to the B&S node 1100.

Briefly, the processing circuitry 1101 of the B&S node 1100 is configured to: receive the first upstream optical signal from a first network node; split a total power of the first upstream optical signal to form a first version of the first upstream optical signal and a second version of the first upstream optical signal; transmit the first version of the first upstream optical signal to a second third network node; and transmit the second version of the first upstream optical signal to a third second network node.

In some embodiments, the B&S node 1100 may optionally comprise a communications interface 1102. The communications interface 1102 of the B&S node 1100 can be for use in communicating with other nodes, such as other virtual nodes. For example, the communications interface 1102 of the B&S node 1100 can be configured to transmit to and/or receive from other nodes requests, resources, information, data, signals, or similar. The processing circuitry 1101 of B&S node 1100 may be configured to control the communications interface 1102 of the B&S node 1100 to transmit to and/or receive from other nodes requests, resources, information, data, signals, or similar.

Optionally, the B&S node 1100 may comprise a memory 1103. In some embodiments, the memory 1103 of the B&S node 1100 can be configured to store program code that can be executed by the processing circuitry 1101 of the B&S node 1100 to perform the method described herein in relation to the B&S node 1100. Alternatively or in addition, the memory 1103 of the B&S node 1100, can be configured to store any requests, resources, information, data, signals, or similar that are described herein. The processing circuitry 1101 of the B&S node 1100 may be configured to control the memory 1103 of the B&S node 1100 to store any requests, resources, information, data, signals, or similar that are described herein.

It will be appreciated that the aforementioned architectures may be extended to other signal and/or network types, for example, mobile radio networks. For example, a fiber ring architecture may connect several mobile sites to a central office, wherein each mobile site comprises radio equipment (such as baseband processing equipment, or a remote radio unit, for example). In some examples, a WDM signal may be terminated in a tunable transceiver that is connected to the radio equipment. In some examples, data signals that have been received from radio equipment (for example, from a plurality of remote radio units) may have a data rate that is smaller than the capacity of an optical wavelength. In these examples, the received data signals may be aggregated onto a single wavelength, for example, by using a switch or a router. In some examples, the switch or the router may comprise a transceiver which is tunable in wavelength, in order to receive/transmit an optical signal at a selected wavelength.

Embodiments described herein thereby enable costs in a B&S network to be moved from an OADM node (which would require upfront payment that is independent of traffic growth within a network) to a reconfigurable transceiver at the tail end nodes, thereby enabling costs to depend on network growth. The B&S nodes described herein are also cost effective as a result of their architecture. In other words, the power splitters (and in some embodiments optional variable optical attenuators) are relatively cheap to procure.

Additionally, embodiments described herein allow for single fiber operation in a B&S network, thereby simplifying installation. In other words, there is no need to completely duplicate the upstream fiber ring or the downstream fiber ring.

Embodiments described herein are additionally compatible with optical amplification, which may mitigate power losses that may occur due to the use of the power splitter-based B&S node architectures. Embodiments described herein additionally enable traffic protection within a B&S network without requiring duplication of both the fiber rings and the network nodes.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A first Broadcast-and-Select (B&S) node comprising:
a first downstream port coupled to a first downstream power splitter/combiner;
a second downstream port coupled to a second downstream power splitter/combiner; and
a third downstream port coupled to a third downstream power splitter/combiner;
wherein:
the first downstream power splitter/combiner is configured to split a total power of a first downstream optical signal received at the first downstream port to form a first version and a second version of the first downstream optical signal;
the second power splitter/combiner is configured to: receive the first version of the first downstream optical signal, and transmit the first version of the first downstream optical signal to a first network node via the second downstream port;
the third downstream power splitter/combiner is configured to: receive the second version of the first downstream optical signal, and transmit the second version of the first downstream optical signal to a second network node via the third port.

2. The first B&S node according to claim 1, wherein the frequency characteristics of the first downstream optical signal, the first version of the first downstream optical signal, and the second version of the first downstream optical signal are substantially the same.

3. The first B&S node according to claim 1, wherein:
the third downstream power splitter/combiner is further configured to: split a total power of a second downstream optical signal received at the third downstream port to form a first version and a second version of the second downstream optical signal,
the second downstream power splitter/combiner is further configured to: receive the first version of the second downstream optical signal and transmit the first version of the second downstream optical signal to the first network node via the second downstream port,
the first downstream power splitter/combiner is further configured to: receive the second version of the second downstream optical signal and transmit the second version of the second downstream optical signal to a third network node via the first port,
the first downstream port is coupled to a first variable bidirectional amplifier that is configured to variably amplify the first downstream optical signal, or to variably amplify the second version of the second downstream optical signal, and
the third downstream port is coupled to a second variable bidirectional amplifier that is configured to variably amplify the second downstream optical signal, or to variably amplify the second version of the first downstream optical signal.

4. The first B&S node according to claim 3, wherein the frequency characteristics of the second downstream optical signal, the first version of the second downstream optical signal, and the second version of the second downstream optical signal are substantially the same.

5. The first B&S node according to claim 3, wherein the first B&S node forms part of a B&S network, and wherein the first B&S node is configured to:
receive the first downstream optical signal responsive to either: no fault occurring between a first downstream port of a hub node in the B&S network and the first downstream port of the first B&S node or no fault occurring in the entire B&S network; or
receive the second downstream optical signal responsive to a fault occurring between the first downstream port of the hub node and the first downstream port of the first B&S node.

6. The first B&S node according to claim 3, wherein the first B&S node further comprises a first downstream variable attenuator configured to variably adjust an optical power level of the first version of the first downstream optical signal prior to the receipt of the first version of the first downstream optical signal by the second power splitter/combiner.

7. The first B&S node according to claim 1, wherein the first B&S node further comprises a second downstream variable attenuator configured to variably adjust an optical power level of the first version of the second downstream optical signal prior to the receipt of the first version of the second downstream optical signal by the second power splitter/combiner.

8. The first B&S node according to claim 1, wherein the second downstream port is coupled to a fourth power splitter/combiner that is configured to separate a third downstream optical signal output by the second downstream port into a predetermined number of optical signals, wherein the third downstream optical signal is based on either the first version of the first downstream optical signal or the first version of the second downstream optical signal.

9-10. (canceled)

11. A second Broadcast-and-Select (B&S) node comprising:
a first upstream port coupled to a first upstream power splitter/combiner;
a second upstream port coupled to a second upstream power splitter/combiner; and
a third upstream port coupled to a third upstream power splitter/combiner;
wherein:
the second upstream power splitter/combiner is configured to split a total optical power of a first upstream optical signal received at the second upstream port to form a first version and a second version of the first upstream optical signal;
the first upstream power splitter/combiner is configured to receive the first version of the first upstream optical signal and transmit the first version of the first upstream optical signal to a third network node via the first upstream port; and
the third upstream power splitter/combiner is configured to receive the second version of the first upstream optical signal and transmit the second version of the first upstream optical signal to a second network node via the third upstream port.

12. The second B&S node according to claim 11, wherein the frequency characteristics of the first upstream optical signal, the first version of the first upstream optical signal, and the second version of the first upstream optical signal are substantially the same.

13. The second B&S node according to claim 11, wherein the second B&S node further comprises a first upstream variable attenuator that is configured to adjust an optical power level of the first version of the first upstream optical signal prior to the receipt of the first version of the first upstream optical signal by the first upstream power splitter/combiner.

14. The second B&S node according to claim 11, wherein:
the second B&S node further comprises a second upstream variable attenuator that is configured to adjust an optical power level of the second version of the first upstream optical signal prior to the receipt of the second version of the first upstream optical signal by the third upstream power splitter/combiner,
the second port is coupled to a fifth power splitter/combiner that is configured to form the first upstream optical signal based on one or more partial optical signals received from a first network node,
the first upstream power splitter/combiner is configured to add the first version of the first upstream optical signal to a second upstream optical signal received from the third upstream power/splitter combiner to generate an updated second upstream optical signal, and
the third upstream power splitter/combiner is configured to add the second version of the first upstream optical signal to a third upstream optical signal received from the first power/splitter combiner to generate an updated third upstream optical signal.

15-16. (canceled)

17. The second B&S node according to claim 11, wherein the first upstream port is coupled to a first directional amplifier that is configured to variably amplify the updated second upstream optical signal.

18. (canceled)

19. The second B&S node according to claim 11, wherein the third upstream port is coupled to a second directional amplifier that is configured to variably amplify the updated third upstream optical signal.

20-42. (canceled)

43. A third Broadcast-and-Select (B&S) node for dropping a downstream optical signal at the third B&S node, wherein the downstream optical signal is intended to be received at a plurality of B&S nodes, the third B&S node comprising processing circuitry configured to:
receive a first downstream optical signal from a third network node;
split a total optical power of the first downstream optical signal to form a first version of the first downstream optical signal and a second version of the first downstream optical signal;
transmit the first version of the first downstream optical signal to a first network node; and
transmit the second version of the first downstream optical signal to a second network node.

44-46. (canceled)
